(19) United States
(12) Patent Application Publication
(10) Pub. No.: US 2008/0276739 A1
(43) Pub. Date: Nov. 13, 2008

(54) Power Transmission Apparatus

(76) Inventor: Chang Kun Baek, Busan (KR)

Correspondence Address: BOOTH UDALL, PLC, 1155 W. Rio Salado Pkwy., Suite 101, Tempe, AZ, 85281, US

(21) Appl. No.: 12/096,251

(22) PCT Filed: Jan. 31, 2006
(86) PCT No.: PCT/KR2006/000328

§ 371 Date: Jun. 5, 2008

(30) Foreign Application Priority Data
Dec. 9, 2005 (KR) 10-2005-0120339

(51) Int. Cl. F16H 61/26

(52) U.S. Cl. 74/412 R

(57) ABSTRACT

The present invention relates to a power transmission apparatus having a high efficiency, which can cany out the rolling friction by constructing a cross shaft gear comprising a plurality of teeth formed with teeth grooves inclined to a desired angle, and a roller type mediation member having a plurality of rotation teeth engaged with the teeth grooves of the gear to thereby prevent the loss of the power and ensure the reliability of the operation and make it easy to fabricate, so as to embody the chainless power transmission for a bicycle. The power transmission apparatus of the present invention comprises a first gear having a first rotation shaft, a disk body installed at the first rotation shaft, a plurality of teeth arranged at a periphery of the disk body in the radial direction, and a plurality of teeth grooves, each of which is formed between the teeth and is arranged to define an acute angle relative to a virtual plane formed by the disk body; a mediation member having two rotation bodies spaced apart from each other, and a plurality of rotation teeth rotatably secured between the two rotation bodies by means of shaft pins so as to be engaged with the teeth grooves of the first gear, and in which an axial line of the pair of rotation bodies is arranged to define an acute angle relative to an axial line of the rotation tooth; and wherein the first gear and the mediation member define a cross shaft gear.

### TECHNICAL FIELD

The present invention relates to a power transmission apparatus constituting a cross shaft gear, and more particularly to a power transmission apparatus having a high efficiency, which makes it possible to carry out rolling friction by constructing the cross shaft gear comprising a plurality of gears formed with teeth grooves inclined to a desired angle, and a roller type mediation member having a plurality of rotation teeth engaged with the teeth grooves of the gear to thereby reduce the friction coefficient so that it is possible to prevent the loss of the power and ensure the reliability of the operation and make it easy to fabricate, so as to embody the chainless power transmission for a bicycle.

### BACKGROUND ART

To realize a chainless bicycle, several conventional technologies have been developed such as disclosed in Korea patent application laid open No. 1995-0029129 (1995. Nov. 22) entitled with “A bicycle of a bevel gear driven shaft power transmission type bicycle”, Korea patent registration No. 0217891 (1999. Jun. 7) entitled with “A chainless bicycle for an auto transmission apparatus”, Korea patent registration No. 0414889 (2003. Dec. 29) entitled with “A gear member for a chainless power transmission”, Korea patent registration No. 0491743 (2005, May, 18), entitled with “A power transmission apparatus of a bicycle”, and Korea patent registration No. 0527093 (2005. 110.01) entitled with “An apparatus for forming a curved tooth shape of the sprocket gear for transmitting the power of the chainless bicycle”, and the like.

The technical tasks to be accomplished in the field of the power transmission apparatus for the conventional chainless bicycle are to transfer the force applied of the crank connected to the pedal to the rear wheels reliably, to ensure the low production cost corresponding to the chain type power transmission apparatus, and to realize the transmission gear commercialized in the chain type power transmission apparatus.

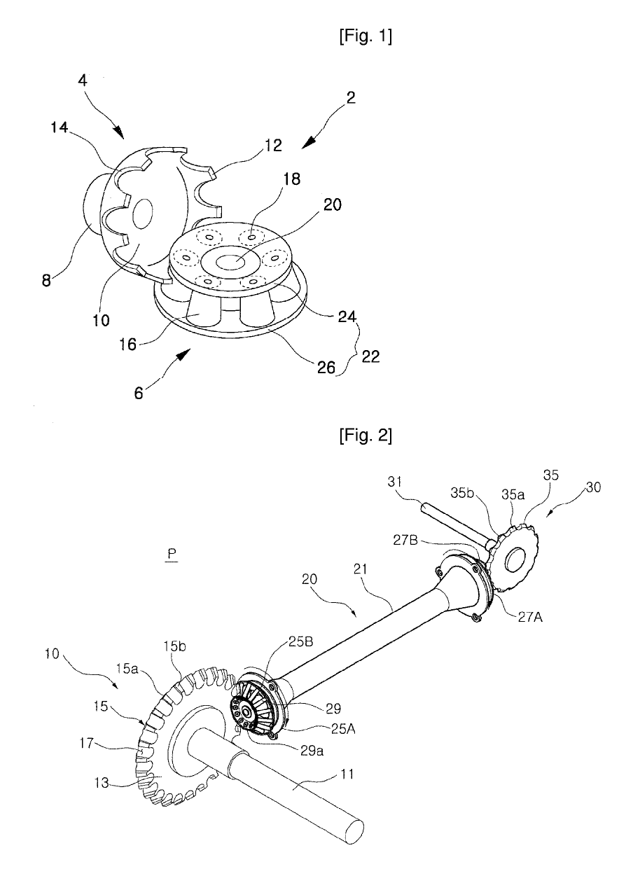

In particular, as shown in FIG. 1, in Korean patent No. 0414889, there was disc losed a gear member for transmitting the power comprising a crown gear 4 formed with a plurality of gear teeth 12 having a predetermined inclination to the outside around the edge of a disk portion 10 with a hollow pipe 8 and tooth grooves 14 having predetermined curvature between the gear teeth 12, and a roller gear 6 constructed by a plurality of roller teeth 16 arranged to vertically engage with the gear teeth 12 of the crown gear 4 with predetermined inclination and interval relative to the axial line and a multi-stage disk portion 22 formed of upper and lower disk portions 24, 28 arranged with predetermined inclination relative to an axial tube 20 and securing the upper and lower shaft pins 18 of the roller teeth 16.

However, because the teeth grooves 14 of the crown gear 4 were big in contacting area with the roller teeth 16 of the roller gear 6, it is probable that the power consumption due to the friction would still be big, and big and sharp noises would occur.

Especially, because the gear teeth 12 of the crown gear 4 should be machined to be inclined from the disk portion 10 by a predetermined angle, there occurs a problem that the cost is increased to machine the gear teeth by cutting while ensuring proper strength and wear resistant property. Further, the manufacturing cost is increased because the roller teeth 16 are formed in a frusto-conical shape.

Such an increase in the manufacturing cost is one of the most serious and urgent problems to be solved in consideration of the circumstances of the post started manufacturers with regard to the chainless bicycles, who should guarantee the supply cost identical to or lower than that of the chain type bicycle that occupies the market overwhelmingly, if possible.

### DISCLOSURE OF INVENTION

### Technical Problem

Therefore, the present invention has been made to solve the problems occurring in the conventional arts, and a primary object of the present invention is to provide a power transmission apparatus, which reduces the production cost of the gear and secures the reliability of operation of the mediation member and the teeth constituting the cross shaft gear, by constructing the teeth so that the teeth grooves define acute angles relative to an artificial plane formed by a disk body through the engagement of a plain gear and a chain gear, and constructing the mediation member having a plurality of roller type rotation teeth engaging with the teeth grooves.

Another object of the present invention is to a power transmission apparatus, which can prevent the power loss and reduce the amounts of the occurrence of the noise by fabricating the rotation teeth of the mediation member to be cylindrical shape to thereby reduce the production cost, and arranging the lower surface of the teeth grooves of the gear to be spaced apart from the rotation teeth of the mediation member to reduce the contacting area to thereby decrease the friction coefficient.

Still another object of the present invention is to provide a power transmission apparatus, which prevents the possibility of the teeth ends of the gear to be contacted with the two rotation bodies having the rotation teeth of the mediation member secured by forming chamfering machined portions in the direction of the rotation shaft at the ends of the teeth of the gear.

### Technical Solution

To solve such objects of the present invention, there is provided a power transmission apparatus comprising: a first gear having a first rotation shaft, a disk body installed at the first rotation shaft, a plurality of teeth arranged at a periphery of the disk body in the radial direction, and a plurality of teeth grooves, each of which is formed between the teeth and is arranged to define an acute angle relative to a virtual plane formed by the disk body; and a mediation member having a pair of rotation bodies spaced apart from each other, and a plurality of rotation teeth rotatably secured between the two rotation bodies by means of shaft pins so as to be engaged with the teeth grooves of the first gear, wherein an axial line of the pair of rotation bodies is arranged to define an acute angle relative to an axial line of the rotation tooth, whereby the first gear and the mediation member define a cross shaft gear.

### ADVANTAGEOUS EFFECTS

Accordingly, according to the present invention, it is possible to reduce the production cost of the gear and secures the reliability of operation of the mediation member and the teeth constituting the cross shaft gear, by constructing the teeth so that the teeth grooves define acute angles relative to an artificial plane formed by a disk body through the engagement of a plain gear and a chain gear, and constructing the mediation member having a plurality of roller type rotation teeth engaging with the teeth grooves. Also, it is possible to remove the power loss and reduce the amounts of the occurrence of the noise by fabricating the rotation teeth of the mediation member to be cylindrical shape to reduce the production cost, and arranging the lower surface of the teeth grooves of the gear to be spaced apart from the rotation teeth of the mediation member to reduce the contacting area to thereby decrease the friction. Further, it is possible to prevent the possibility of the teeth end of the gear to be contacted with the two rotation bodies having the rotation teeth of the mediation member secured by forming chamfering machined portions in the direction of the rotation shaft at the end of the teeth of the gear.

### MODE FOR THE INVENTION

Hereinafter, the present invention will be explained in detail with reference to the appended drawings below.

FIG. 1 is a perspective view showing FIG. 1 of the conventional art disclosed in the publication of the Korea patent registration No. 0414889,

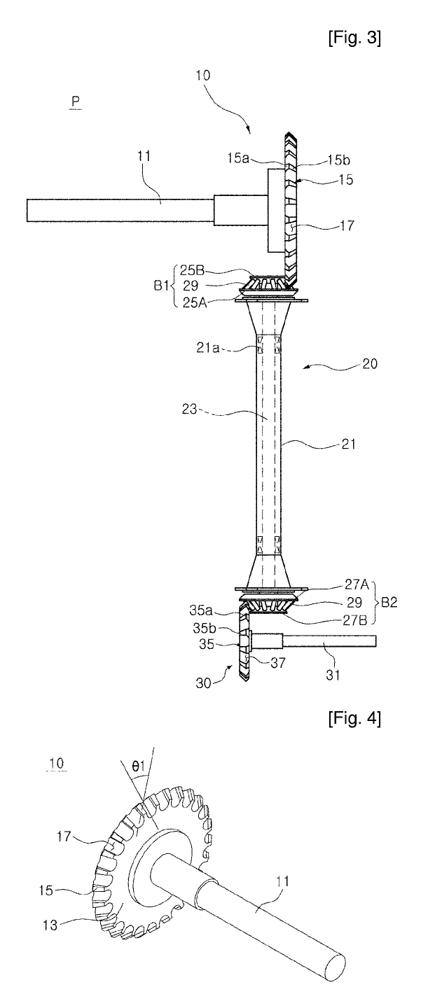

FIGS. 2 and 3 are an engagement perspective view and a plan view showing a power transmission apparatus according to the present invention,

FIG. 4 is a perspective view of a first gear of the power transmission apparatus according to the present invention,

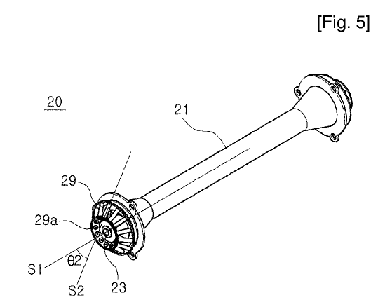

FIG. 5 is a perspective view of the mediation member in the power transmission apparatus of the present invention.

For reference, the reference numerals of FIG. 1 related to the Korea patent registration No. 0414889 and the reference numerals shown in FIGS. 2 through 5 of the present invention are different from those shown in FIG. 1.

In the following description of the present invention, it is to be understood that the present invention will be described with reference to the power transmission apparatus A for a chainless bicycle, however, the present invention should not be limited to such embodiments.

Referring to FIG. 2 and FIG. 3, the power transmission apparatus of the present invention comprises first and second gears 10, 30 and a mediation member 20 coupled to operate with the two gears.

The first gear 10 includes a first rotation shaft 11, and a disk body 13 installed on the first rotation shaft, and a plurality of teeth 15 formed at a periphery of the disk with spaced apart from each other uniformly in the radial direction and having teeth grooves there-between. The second tooth 30 is also formed with a disk body having a plurality of teeth 35 and teeth grooves there-between as is the first tooth.

The mediation member 20 having a plurality of roller type rotation teeth 29 engaging with the teeth grooves 17 of the respective gear 10, 30 includes a rotation rod 23 installed at the inside of an outer clothes with the outer clothes 21 and a bearing 21a there-between, and wherein the two rotation bodies, in particular, the disk type rotation bodies 25A, 25B; 27A, 27B are installed at both ends of the rotation rod 23 so that they are exposed to the outside of the outer clothes 21, to thereby make the plurality of the rotation bodies 29 and the two pairs of the rotation bodies 25A, 25B; 27A, 27B construct the two roller gear units B1, B2 respectively.

The gist of the present invention is that an angle θ1 defined by the teeth grooves 17 of the gears 10, 30 and an artificial plane made by the disk body 13 becomes to be preferably an acute angle, more preferably be 40˜50 degrees, and be most preferably 45 degrees to thereby minimize the loss of the driving force so that each of the gears 10, 30 and the mediation member 20 can constitute the cross shaft gear as shown in detail in FIG. 4. Further, in general, an angle θ2 defined between the first rotation shaft 11 of the first gear 10 constructing the crank shaft (not shown) and an axial line S1 (confer FIG. 5) of a pair of the rotation bodies 25A, 25B of the mediation member 20, that is, a center line of the rotation rod 23, becomes to be vertical, and also an angle defined between the second rotation shaft 31 of the second gear 30 constructing the crank shaft (not shown) and an axial line S1 (confer FIG. 4) of a pair of the rotation bodies 27A, 27B of the mediation member 20, that is, a center line of the rotation rod 23, becomes to be vertical. Accordingly, if the angle θ1 defined by the respective tooth groove 17 of the gears 10, 30 and an artificial plane formed by the disk body 13 becomes to be an acute angle, as shown in FIG. 5, an angle θ2 defined by the axial line S1 formed by the pairs of the rotation bodies 25A, 25B; 27A, 27B of the mediation member 20 and the axial line S2 of the rotation tooth 29 becomes to be preferably an acute angle, more preferably be 40˜50 degrees, and most preferably be 45 degrees so that an angle formed between the first and second rotation shafts 11, 31 and the rotation rod 23 can become a vertical angle.

The specification (45 degrees or in the vicinity of those degrees) of the two angles θ1, θ2 is the result of our experiments obtained from the discovery of the least loss of the driving force when the bicycle is constructed of the power transmission apparatus of the present invention. As a result of such specification (45 degrees) of the angles θ1, θ2, if the respective angle defined by the axial lines formed between each of the two gears and the mediation member 20 is vertical, the efficiency of the mass production can be increased as the angle defined between the tooth groove 17 of the gear and the rotation tooth can be adjusted to be 45 degrees.

Further, as shown in FIGS. 2 through 5, the rotation tooth 29 of the mediation member 20 is a hollow cylindrical shape, it is easy to fabricate and assemble the rotation tooth itself in comparison with the case of the clutch 16 being a frusto-conical cylindrical shape as disclosed in Korea patent registration No. 0414889. In such a case, an shaft pin 29a arranging and securing the rotation tooth 29 between the two rotation bodies 25A, 25B; 27A, 27B is arranged to define an acute angle between the axial line S1 of the respective pairs of the rotation bodies, that is, a center line of the rotation rod 23.

Next, when the lower surface of the tooth groove 17 of the first and second gears 10, 30 is arranged to be spaced apart from the rotation tooth 29 of the mediation member 20, it is possible to reduce the contacting area so that the friction can be reduced to minimize the loss of the driving force and reduce the possibility of the occurrence of the noise.

Further, because chamfering machined portions 15a, 15b;35a, 35b are formed in a direction identical with that of the first and second rotation shafts 11, 31 at the end of the teeth 15 of the first gear 10, 30, it is possible to block the possibility of the rotation teeth 29 of the mediation member 20 be contacted with the secured respective rotation bodies 25A, 25B;27A, 27B to thereby remove the possibility of the occurrence of the friction.

In the above description, while the connection relations between the first gear 10, the mediation member 20, and the second gear 30 have been principally described in consideration of the construction of the power transmission apparatus for the chainless bicycle, as described above, the power transmission apparatus A of the present invention can be applied to other products. In this regard, as described in claim 1 of the present specification, it is possible to realize the product by changing the power transmission apparatus constructed of the first gear 10 and any one of the two roller gear units B1, B2 variously.

In addition, as shown in FIG. 3, the power transmission apparatus of the present invention can be constructed that the disk body 13 of the first gear 10 is arranged at the right of the roller gear unit B1 of the mediation member 20, the disk body 33 of the second gear 30 is arranged at the left of the roller gear unit B2 of the mediation member B2, and the rotation tooth 29 and the teeth grooves 17, 37 are formed to correspond to these structures. Also, whole of the two gears can be arranged at the right or at the left and the two roller gear units can be arranged at the right or at the left. Further, it is possible to arrange the first gear at the left and the second gear at the right with centering the two roller gear units, opposing to the drawings. In addition, it is possible to construct the angle defined by the respective gear and the axial line of the mediation member is more or less than 90 degrees.

However, it is desirable that the construction of the power transmission apparatus be arranged as described and shown in the drawings, in case of constructing the chainless bicycle. Further, the ratio of the teeth of the first and second sprockets and the rotation tooth of the mediation member can be selected variously according to the use purpose of the power transmission apparatus.

### INDUSTRIAL APPLICABILITY

As described above, according to the present invention, it is possible to reduce the production cost of the gear and secures the reliability of operation of the mediation member and the teeth constituting the cross shaft gear, by constructing the teeth so that the teeth grooves define acute angles relative to an artificial plane formed by a round plate body through the engagement of a plane gear and a chain gear, and constructing the mediation member having a plurality of roller type rotation teeth engaging with the teeth grooves.

Also, it is possible to remove the power loss and reduce the amounts of the production of the noise by fabricating the rotation teeth of the mediation member to be a cylindrical shape to reduce the production cost, and arranging the lower surface of the teeth grooves of the gear to be spaced apart from the rotation teeth of the mediation member to reduce the contacting area to thereby decrease the friction.

Further, it is possible to prevent the possibility of the teeth end of the gear to be contacted with the two rotation bodies having the rotation teeth of the mediation member secured by forming chamfering machining portions in the direction of the rotation shaft at the end of the teeth of the gear.

While the present invention has been described with reference to the specific shapes and structures of the power transmission apparatus of the present invention, the present invention is not limited by the embodiments. And, it is to be understood that those skilled in the art can change or modify the embodiments without departing from the scope and spirit of the present invention. However, such variations and modifications are all pertained to the scope of the present invention.

1. A power transmission apparatus comprising:
a first gear having a first rotation shaft, a disk body installed at the first rotation shaft, a plurality of teeth arranged at a periphery of the disk body in the radial direction, and a plurality of teeth grooves, each of which is formed between the teeth and is arranged to define an acute angle relative to a virtual plane formed by the disk body; and a mediation member having a pair of rotation bodies spaced apart from each other, and a plurality of rotation teeth rotatably secured between the two rotation bodies by means of shaft pins so as to be engaged with the teeth grooves of the first gear, wherein an axial line of the pair of rotation bodies is arranged to define an acute angle relative to an axial line of the rotation tooth, whereby the first gear and the mediation member define a cross shaft gear.

2. The power transmission apparatus according to claim 1, wherein each of the rotation teeth of the mediation member is formed in a hollow cylindrical shape, and the shaft pins are arranged to define an acute angle relative to the axial line of the pair of the rotation bodies.

3. The power transmission apparatus according to claim 1, wherein a lower surface of the teeth grooves of the first gear is spaced apart from the rotation teeth of the mediation member.

4. The power transmission apparatus according to claim 1, wherein the mediation member 20 includes an outer clothes, and a rotation rod installed at the inside of the outer clothes, and the two rotation bodies are installed at one end or at both ends of the rotation rod in such a fashion as to be exposed to the outside of the outer clothes, and the rotation teeth are arranged to define an acute angle relative to the rotation rod.

5. The power transmission apparatus according to claim 4, wherein a bearing is interposed between the outer clothes of the mediation member and the rotation rod.

6. The power transmission apparatus according to claim 1, wherein the first gear is formed with chamfering machined portions at the ends of the teeth in the direction aligning with the direction of the first rotation shaft.

7. The power transmission apparatus according to claim 1, wherein the first rotation shaft is a crank-shaft.

8. The power transmission apparatus according to claim 1, further comprising a second gear having a second rotation shaft, a disk body installed at the second rotation shaft, a plurality of teeth formed at a periphery of the disk body in the radial direction, and a plurality of teeth grooves formed between the teeth grooves and forming an acute angle relative to a virtual plane defined by the disk body.

9. The power transmission apparatus according to claim 2, wherein the first gear is formed with chamfering machined portions at the ends of the teeth in the direction aligning with the direction of the first rotation shaft.

10. The power transmission apparatus according to claim 3, wherein the first gear is formed with chamfering machined portions at the ends of the teeth in the direction aligning with the direction of the first rotation shaft.

11. The power transmission apparatus according to claim 4, wherein the first gear is formed with chamfering machined portions at the ends of the teeth in the direction aligning with the direction of the first rotation shaft.

12. The power transmission apparatus according to claim 5, wherein the first gear is formed with chamfering machined portions at the ends of the teeth in the direction aligning with the direction of the first rotation shaft.

13. The power transmission apparatus according to claim 2, further comprising a second gear having a second rotation shaft, a disk body installed at the second rotation shaft, a plurality of teeth formed at a periphery of the disk body in the radial direction, and a plurality of teeth grooves formed between the teeth grooves and forming an acute angle relative to a virtual plane defined by the disk body.

14. The power transmission apparatus according to claim 3, further comprising a second gear having a second rotation shaft, a disk body installed at the second rotation shaft, a plurality of teeth formed at a periphery of the disk body in the radial direction, and a plurality of teeth grooves formed between the teeth grooves and forming an acute angle relative to a virtual plane defined by the disk body.

15. The power transmission apparatus according to claim 4, further comprising a second gear having a second rotation shaft, a disk body installed at the second rotation shaft, a plurality of teeth formed at a periphery of the disk body in the radial direction, and a plurality of teeth grooves formed between the teeth grooves and forming an acute angle relative to a virtual plane defined by the disk body.

16. The power transmission apparatus according to claim 5, further comprising a second gear having a second rotation shaft, a disk body installed at the second rotation shaft, a plurality of teeth formed at a periphery of the disk body in the radial direction, and a plurality of teeth grooves formed between the teeth grooves and forming an acute angle relative to a virtual plane defined by the disk body.

17. The power transmission apparatus according to claim 2, wherein the first rotation shaft is a crank-shaft.

18. The power transmission apparatus according to claim 3, wherein the first rotation shaft is a crank-shaft.

19. The power transmission apparatus according to claim 4, wherein the first rotation shaft is a crank-shaft.

20. The power transmission apparatus according to claim 5, wherein the first rotation shaft is a crank-shaft.
